(19) United States
(12) Patent Application Publication
(10) Pub. No.: US 2026/0281051 A1
(43) Pub. Date: Sep. 17, 2026

(54) APPARATUS AND METHOD FOR DETERMINISTIC NETWORKING PACKET PROCESSING IN COMMUNICATION SYSTEM

(71) Applicant: ELECTRONICS AND TELECOMMUNICATIONS RESEARCH INSTITUTE, Daejeon (KR)

(72) Inventors: Tae Kyu KANG, Daejeon (KR); Chang Ho CHOI, Daejeon (KR); Tae Sik CHEUNG, Daejeon (KR); Woo Young CHOI, Daejeon (KR)

(73) Assignee: ELECTRONICS AND TELECOMMUNICATIONS RESEARCH INSTITUTE, Daejeon (KR)

(21) Appl. No.: 19/562,358

(22) Filed: Mar. 10, 2026

(30) Foreign Application Priority Data
Mar. 11, 2025 (KR) 10-2025-0031205

(51) Int. Cl. H04L 47/34; H04L 45/745; H04L 47/32

(52) U.S. Cl. CPC H04L 47/34; H04L 45/745; H04L 47/32

(57) ABSTRACT

Provided is an apparatus for deterministic networking packing processing in a communication system. The apparatus includes a network interface block, a system interface block, a time synchronization interface block, a processor interface block, a packet processing block group, and a packet buffering block. The packing processing block group includes a flow lookup block for identifying flow of a best-effort packet, an in-time packet, or an on-time packet and generating metadata, a flow sequence check block for verifying a sequence number of a packet, a filtering and policing block for filtering and policing the packet, a packet header processing block for processing a packet header, and an output scheduling block for scheduling the packet for each traffic class.

### CROSS-REFERENCE TO RELATED APPLICATIONS

This application claims priority under 35 U.S.C. § 119 to Korean Patent Application No. 10-2025-0031205 filed on Mar. 11, 2025, in the Korean Intellectual Property Office, the disclosures of which are incorporated by reference herein in their entireties.

### BACKGROUND

Embodiments of the present disclosure described herein relate to a communication system, and more particularly, relate to an apparatus and a method for deterministic networking packing processing in the communication system.

There are an IEEE time sensitive networking (TSN) technology and an IETF deterministic networking (DetNet) technology as international standardization technologies for providing deterministic latency in a communication network.

The IEEE TSN is an OSI layer 2 Ethernet-based networking technology for providing end-to-end low-latency time sensitive packet forwarding and high-precision mission-critical packet forwarding in a local area network, such as cars, airplanes, factories, or buildings. The TSN provides strict time synchronization and a crucial packet forwarding scheme to ensure transmission of data sensitive to time in a local area network environment.

The IETF DetNet is an OSI layer 3 IP or MPLS-based networking technology including TSN expansion via domain interworking in a business-scale enterprise or a wide area network and for providing forwarding of end-to-end low-latency time sensitive and high-precision mission-critical packets.

The DetNet basically supports a TSN forwarding scheme (e.g., queuing, scheduling, or the like) and simultaneously provides a separate mechanism for making it wide-ranging. As a result, the DetNet was designed to facilitate a deterministic networking service even in a wide area network environment.

A packet processing device in wide area network equipment currently released does not support a deterministic networking technology for forwarding of an end-to-end low-latency time sensitive packet (e.g., augmented reality (AR), virtual reality (VR), mixed reality (MR), or the like) and a high-precision mission-critical packet (e.g., industry control, remote surgery, or the like). Particularly, because a bandwidth, maximum allowable latency, a minimum latency deviation, no-loss, or the like is unable to be ensured in a congestion situation with an existing best-effort packet, it is difficult to provide a deterministic service in a wide area network environment.

### SUMMARY

Embodiments of the present disclosure provide an apparatus and a method for deterministic packing processing for a line unit of wide area network equipment in a communication system.

Embodiments of the present disclosure provide an apparatus and a method for forwarding a low-latency packet within a fast time (in-time) in a communication system.

Embodiments of the present disclosure provide an apparatus and a method for forwarding a high-precision packet in an accurate time (on-time) in a communication system.

Embodiments of the present disclosure provide an apparatus and a method for ensuring a differentiated forwarding time according to a characteristic of a packet in a communication system.

Embodiments of the present disclosure provide an apparatus and a method for making packing processing for deterministic networking wide-ranging in a communication system.

According to an embodiment, an apparatus for deterministic networking packing processing in a communication system may include a network interface block, a system interface block, a time synchronization interface block, a processor interface block, a packing processing block group, and a packet buffering block. The packing processing block group may include a flow lookup block that identifies flow of a best-effort packet, an in-time packet, or an on-time packet and generates metadata, a flow sequence check block that verifies a sequence number of a packet, a filtering and policing block that filters and polices the packet, a packet header processing block that processes a packet header, and an output scheduling block that schedules the packet for each traffic class.

According to an embodiment, a method for deterministic networking packing processing in a communication system may include receiving a packet, identifying flow of a best-effort, in-time, or on-time packet, and generating metadata, verifying a sequence number of the packet, filtering and policing the packet, processing a packet header, and scheduling the packet for each traffic class.

### BRIEF DESCRIPTION OF THE FIGURES

The above and other objects and features of the present disclosure will become apparent by describing in detail embodiments thereof with reference to the accompanying drawings.

FIG. 1 illustrates the concept of a deterministic network according to an embodiment of the present disclosure.

FIG. 2 illustrates a structure of a deterministic packing processing module according to an embodiment of the present disclosure.

FIG. 3 illustrates a configuration of a line unit loaded with a deterministic packing processing module according to an embodiment of the present disclosure.

FIG. 4 illustrates an example of implementing a deterministic line unit according to an embodiment of the present disclosure.

FIG. 5 illustrates a structure of deterministic transport network equipment according to an embodiment of the present disclosure.

FIG. 6 illustrates a packing processing method in a deterministic network according to an embodiment of the present disclosure.

FIG. 7 is a drawing illustrating a device configuration according to an embodiment.

### DETAILED DESCRIPTION

Terms used in the present disclosure are used to merely describe specified embodiments and are not intended to limit the scope of another embodiment. The singular expression may include plural expressions unless the context clearly indicates otherwise. The terms used herein, which include technical or scientific terms, may have the same meaning that is generally understood by a person skilled in the art in the technical field described in the present disclosure. Terms defined in a general dictionary among the terms used in the present disclosure may be interpreted as the same or similar meaning as a contextual meaning of related technology, and unless clearly defined in the present disclosure, it is not interpreted in an ideal or excessively formal meaning. In some cases, even if terms are terms which are defined in the present disclosure, they may not be interpreted to exclude embodiments of the present disclosure.

A hardware access method will be described as an example in various embodiments of the present disclosure, which will be described below. However, because various embodiments of the present disclosure include a technology which uses both of hardware and software, they do not exclude a software-based access method.

Furthermore, in the detailed description and claims of the present disclosure, at least one of A, B, and C may refer to “only A”, “only B”, “only C”, or “any combination of A, B, and C”. Furthermore, “at least one of A, B, or C” or “at least one of A, B, and/or C” may refer to at least one of A, B, and C.

Hereinafter, the present disclosure relates to an apparatus and a method for deterministic networking packing processing in a communication system. In detail, the present disclosure describes a technology for ensuring a bandwidth, maximum allowable latency, a minimum latency deviation, no-loss, or the like, although congestion with an existing best-effort packet occurs, when exchanging an end-to-end time sensitive packet (e.g., AR, VR, MR, or the like) and a mission-critical packet (e.g., industry control, remote surgery, or the like) over a wide area network in a communication system.

A term referring to a signal, a term referring to a channel, a term referring to control information, a term referring a network entity, a term referring to a component of a device, and the like, which are used in a description below, are exemplified for convenience of description. Thus, the present disclosure is not limited to terms described below and another term with the equivalent technical meaning may be used.

Furthermore, the present disclosure describes various embodiments using terms used in some communication specifications (e.g., 3rd generation partnership project (3GPP)). This is just an example for illustrative purposes. Various embodiments of the present disclosure are easily modified and applied even in another communication system.

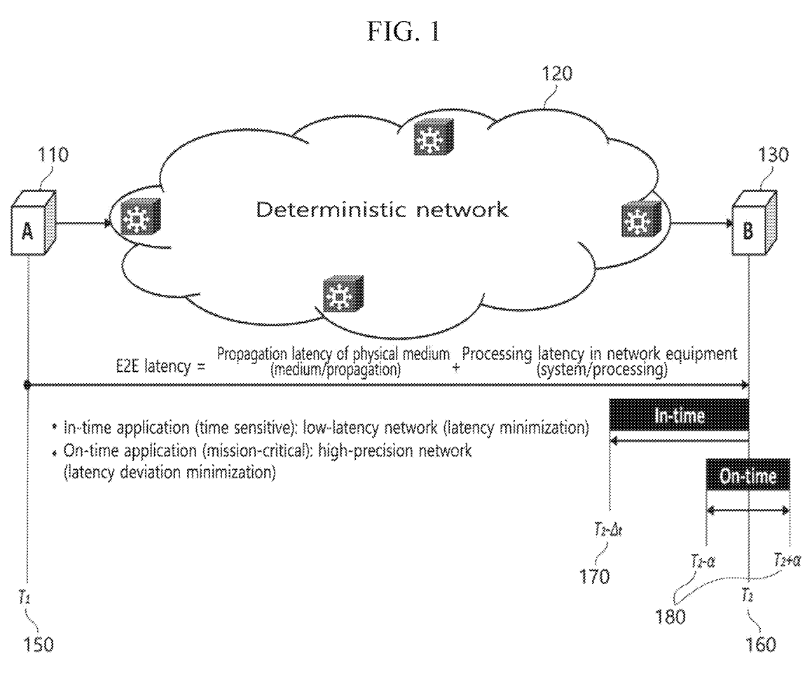

FIG. 1 illustrates the concept of a deterministic network according to an embodiment of the present disclosure.

Referring to FIG. 1, a termination device A 110 for transmitting a packet to a unidirectional (the right from the left) in-time or on-time application and a termination device B 130 for receiving a packet over a deterministic network 120 are illustrated.

End-to-end latency 140 may be calculated as the sum of propagation latency of a physical medium (medium/propagation) and processing latency in network equipment (system/processing).

When the termination device A 110 transmits a packet at time T1150, the termination device B 130 may receive the packet at time T2160 within end-to-end maximum allowable latency. An in-time application, such as augmented reality (AR), virtual reality (VR), or mixed reality (MR), may minimize end-to-end latency to forward a packet as fast as possible (T2-Δt) 170. An on-time application, such industry control or remote surgery, may minimize an end-to-end latency deviation to forward a packet at a desired accurate time (T2±α) 180.

Herein, Δt may indicate latency capable of being reduced by low-latency processing and α may indicate a latency deviation which occurs by high-precision processing.

The in-time application should meet a maximum latency requirement and the on-time application should meet both of the maximum latency requirement and a minimum latency requirement.

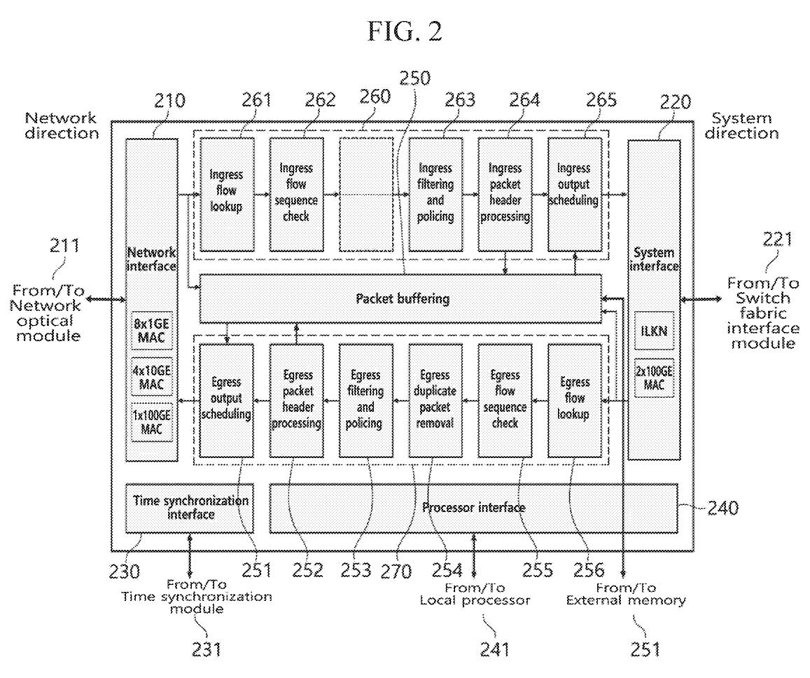

FIG. 2 illustrates a structure of a deterministic packing processing module according to an embodiment of the present disclosure.

Referring to FIG. 2, the deterministic packing processing module may perform a function for ensuring latency quality, such as in-time and on-time, to a destination for some specific application (low-latency or high-precision) packets and forwarding the packet without loss, together with processing a best-effort packet. The deterministic packing processing module may be implemented in the form of a field programmable gate array (FPGA) and may operate in three modes of 8x1 gigabit Ethernet (GE), 4x10 GE, or 1x100 GE depending on programming.

A network interface block 210 may be in charge of data transmission and reception with a network optical module 211. The network interface block 210 may perform a function for converting an Ethernet signal (8x1.25 Gbps/4x10.3125 Gbps or 4x25.78125 Gbps Serial) input via the network optical module 211 into an internal data interface signal (250 MHz, 512 bits Parallel) and delivering the converted internal data interface signal to a flow lookup block 261 (ingress) or converting a packet input via an internal data interface from an output scheduling block 251 into an Ethernet signal and outputting the converted Ethernet signal to the network optical module 211.

A system interface block 220 may be in charge of data transmission and reception with a switch fabric interface module 221. The system interface block 220 may perform a function for converting a packet input via the internal data interface from an ingress output scheduling block 265 into an Interlaken (ILKN) (8x10.3125 Gbps) or 2x100 gigabit Ethernet signal (4x25.78125 Gbps) and delivering the converted Ethernet signal to the switch fabric interface module 221 (ingress) or converting a packet received from the switch fabric interface module 221 into an internal data interface signal and delivering the converted internal data interface signal to an egress flow lookup block 256.

A time synchronization interface block 230 may be used for data transmission and reception with a time synchronization module 231. The time synchronization interface block 230 may extract time information synchronized with a global signal based on a time information signal (e.g., a pulse per second (PPS) or a time of day (TOD)) input from the time synchronization module 231 (IEEE 1588v2) to update a current time and may manage a time by using it as an internal clock before receiving a next time information signal and updating the current time. Furthermore, when the packing processing module synchronously operates, the time synchronization interface block 230 may perform a function for providing it to a block (e.g., network and system interfaces, filtering and policing, output scheduling, or the like) which operates based on time information.

A processor interface block 240 may be used for data transmission and reception with a local processor 241. The processor interface block 240 may convert an external processor signal (10.3125 Gbps Serial, PCIe Gen2) into an internal processor interface signal (125 MHz, 32 bits Parallel) to perform lookup table and register setting and management for each function block via a distributed structure.

Upper ingress-direction packing processing blocks may perform the following functions.

The flow lookup block 261 may perform a table lookup function for identifying best-effort/in-time/on-time packet flow for the packet input via the internal data interface from the network interface block 210 and may perform a header processing function for changing a packet header depending on the result obtained via it if necessary. Furthermore, the flow lookup block 261 may generate contents (e.g., a flow ID, MPLS mapping (FTN/ILM), a priority, a sequence number, a packet size, and the like) obtained as a result of packet analysis and lookup in the form of metadata and may deliver the metadata to a next block independently of the packet of the internal data interface.

A flow sequence check block 262 may perform a table lookup function using the flow ID in the metadata, may check a sequence number of a previous received packet obtained via it to discard a packet with the same sequence number as the previous received packet and may deliver a packet with a sequence number which is not the same as the previous received packet to a filtering and policing block 263.

The filtering and policing block 263 may perform the table lookup function using the flow ID in the metadata and may perform a function, such as filtering and policing for checking whether it is allowed for each flow obtained via it and a bandwidth used, stream gate control for allocating it to each stream gate corresponding to an input packet, specified output available time calculation according to a bandwidth or latency set for each flow, or statistics management and priority resetting for each flow.

A packet header processing block 264 may perform the table lookup function using the flow ID in the metadata and may perform a header processing function including encapsulation/decapsulation (MPLS pop/push/swap or the like) of a packet to be output based on the result obtained via it. The packet header processing block 264 may add a header (e.g., a VLAN ID or an MPLS label) for copying a packet via a switch fabric, when no-loss is required.

The output scheduling block 265 may divide packets for each traffic flow to store a maximum of 8 packets in a configurable class queue and may support the following scheduling scheme.

(1) Strict priority-based forwarding for dividing packets for each traffic flow and transmitting the packets depending on priorities of the traffic classes

(2) Time-aware shaping for dividing and storing packets for each traffic flow in each class queue and controlling a gate operation of a specific class queue in a predetermined time interval to ensure transmission latency of the packet.

(3) Cyclic queuing and forwarding for repeating a process of alternately storing and transmitting packets with the same characteristic in a predetermined time interval using two traffic class queues to finalize latency on a network to be predictable.

(4) Asynchronous traffic shaping for asynchronously controlling the output of packets using an output available time calculated based on a local time

(5) Delay-based forwarding for ensuring in-time/on-time using a push-in-first out (PIFO) queue and resource-based on-time forwarding for improving it

Lower egress-direction packing processing blocks may perform functions similar to the ingress direction, but a duplicate packet removal block 254 may be added between a flow sequence check block 255 and a filtering and policing block 253.

A flow lookup block 256 may perform a table lookup function for identifying best-effort/in-time/on-time packet flow for the packet input via the internal data interface from the system interface block 220 and may perform a header processing function for changing a packet header if necessary. Furthermore, the flow lookup block 256 may generate contents obtained as a result of packet analysis and lookup as metadata and may deliver the generated metadata to a next block.

The flow sequence check block 255 may perform a table lookup function using the flow ID in the metadata, may check a sequence number of a previous received packet to discard a packet with the same sequence number as the previous received packet and may forward a packet with a sequence number which is not the same as the previous received packet to the duplicate packet removal block 254.

The duplicate packet removal block 254 may perform the table lookup function using the flow ID in the metadata, may check reception sequence history obtained via it (or sequence number reception history) to discard a packet when there is previous reception history, and may forward the packet to the filtering and policing block 253. The duplicate packet removal block 254 may perform a function for selecting a packet first received among packets copied and forwarded from another network equipment for lossless forwarding.

The filtering and policing block 253, a packet header processing block 252, and an output scheduling block 251 may perform the same functions as the corresponding blocks in the ingress direction. The processed packet may be finally delivered to the network optical module 211 via the network interface block 210.

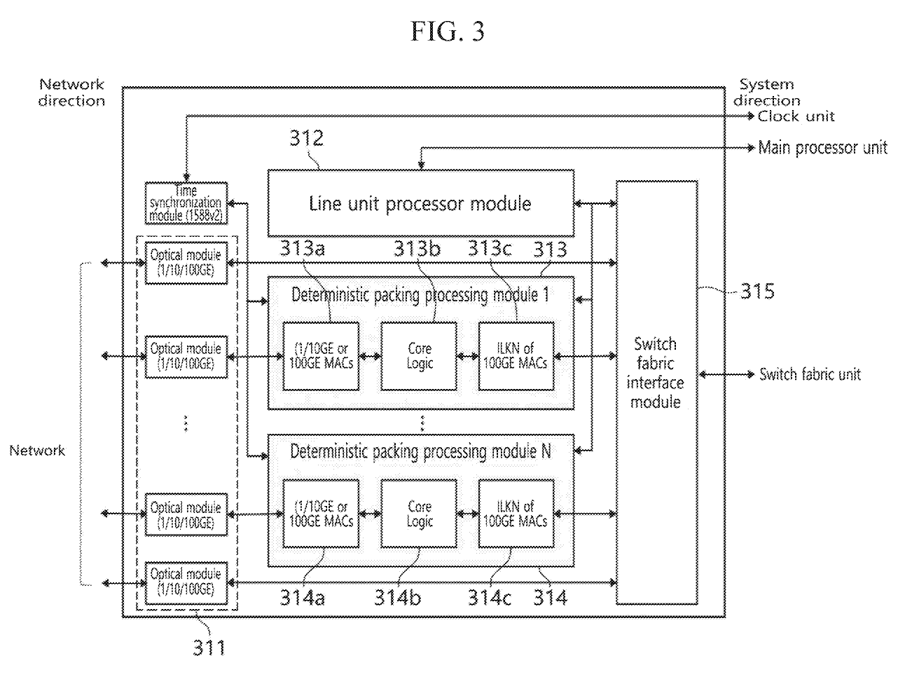

FIG. 3 illustrates a configuration of a line unit loaded with a deterministic packing processing module according to an embodiment of the present disclosure.

Referring to FIG. 3, a deterministic line unit may include an optical module 311, deterministic packing processing modules 313 and 314, a switch fabric interface module 315, a line unit processor module 312, or a time synchronization module.

The optical module 311 may support an optical module (8x1 GE/4x10 GE or 1x100 GE) for providing Ethernet interfaces of three speeds depending on an operation setting of the deterministic packing processing module.

The deterministic packing processing module 313 and 314 may perform a function for ensuring latency quality, such as in-time and on-time, for a low-latency or high-precision packet and forwarding the packet without loss, together with processing a best-effort packet. Each module may be composed of 1/10GE or 100GE MAC 313a or 314a, core logic 313b or 314b, and ILKN or 100GE MAC 313c or 314c.

The switch fabric interface module 315 may perform a function for performing a connection (48x25.78125 Gbps or 48x53.125 Gbps Serial) of the deterministic packing processing module to a switch fabric unit via a back plane. Furthermore, the switch fabric interface module 315 may additionally perform a connection-oriented packet forwarding processing function (MPLS-TP) for the Ethernet interface directly connected via the optical module 311.

The line unit processor module 312 may perform a function for setting operates of components in the unit, which include the deterministic packing processing module, and managing states of the components (a table and a register about resources/paths/QoS or the like). The line unit processor module 312 may provide an interface with a main processor in equipment to receive or transmit items associated with it.

The time synchronization module may generate and deliver a time information signal (e.g., a PPS or a TOD) via a precise time synchronization protocol (e.g., 1588v2 PTP) input over a network to a clock unit or may perform time synchronization in the line unit via a time information signal received from the clock unit.

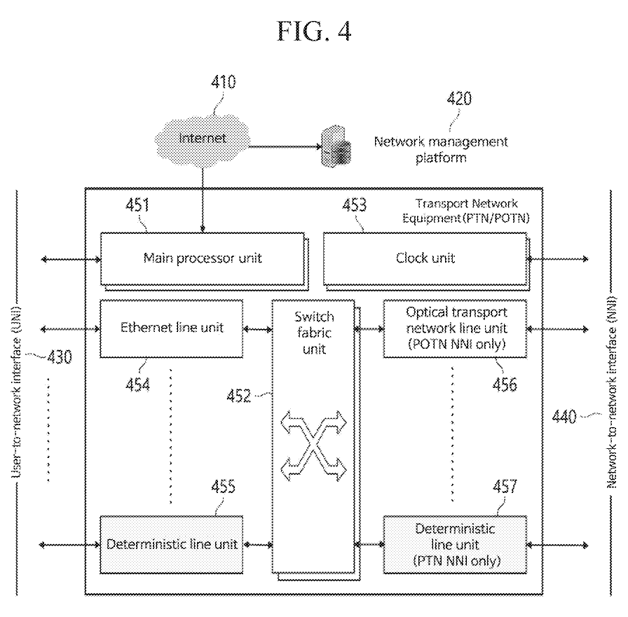

FIG. 4 illustrates an example of implementing a deterministic line unit according to an embodiment of the present disclosure.

Referring to FIG. 4, deterministic transport network equipment 450 may be connected with a network management platform 420 over the Internet 410. An interface of the deterministic transport network equipment 450 may include a user-to-network interface (UNI) 430 with a termination device and a network-to-network interface (NNI) 440 with transport network equipment.

The deterministic transport network equipment 450 may include a main processor unit 451, a switch fabric unit 452, a clock unit 453, and a plurality of line units. The main processor unit 451, the switch fabric unit 452, and the clock unit 453 may provide a redundant (active-standby) configuration to facilitate normal operation although a defect occurs.

The line unit may perform a forwarding function for providing a network connection. The line unit used for a connection with the UNI 430 may include an Ethernet (ETH) line unit 454 and a deterministic (DetNet) line unit 455. The ETH line unit 454 of packet transport network (PTN) equipment may support time sensitive networking (TSN) to interwork with deterministic networking (DetNet).

The line unit used for a connection with the NNI 440 may include an optical transport network (OTN) line unit 456 and a deterministic (DetNet) line unit 457. The OTN line unit 456 may be used for an NNI connection of packet/optical transport network (POTN) equipment and the deterministic (DetNet) line unit 457 may be used for an NNI connection of PTN equipment.

The network management platform 420 may perform a function for collecting pieces of information of pieces of configuration equipment to set a topology, a resource, a path, QoS, or a service of a deterministic network for forwarding of an end-to-end low-latency and high-precision packet, calculating a value based on it, and setting and managing a value corresponding to each piece of transport network equipment.

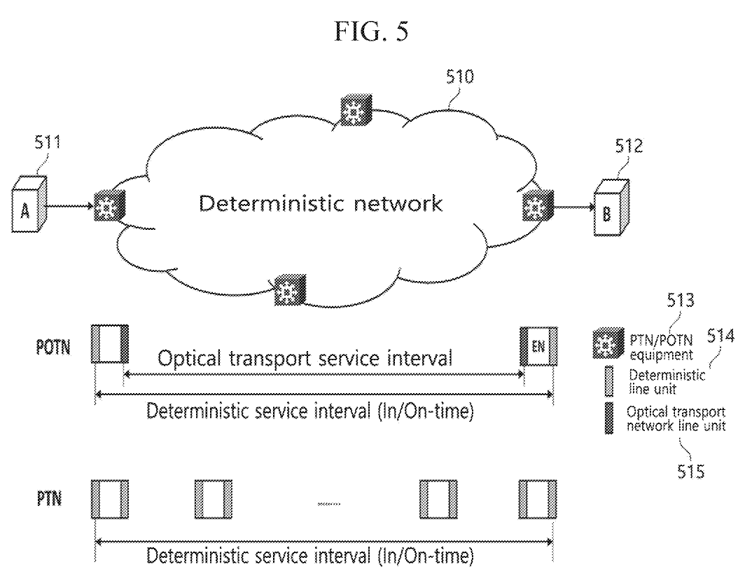

FIG. 5 illustrates a structure of deterministic transport network equipment according to an embodiment of the present disclosure.

Referring to FIG. 5, PTN/POTN equipment 513 may be disposed between a termination device A 511 and a termination device B 512 on a deterministic network 510. Each piece of PTN/POTN equipment 513 may include a deterministic line unit 514 and an optical transport network line unit 515.

For a network to which POTN equipment is applied, equipment connected with the termination device A may perform packet processing about a bandwidth, latency management, and the like for best-effort, low-latency (in-time) or high-precision (on-time) depending on a characteristic via ingress packet processing blocks of the deterministic line unit 514 for the received packet, may convert the processed packet into an OTN frame via the optical transport network line unit 515, may transmit the converted OTN frame to the network. Equipment connected with the termination device B may convert the OTN frame received via the optical transport network line unit 515 into a packet, may perform packing processing for best-effort, low-latency, or high-precision via egress packing processing blocks of the deterministic line unit 514 for the converted packet, and may transmit the processed packet to the termination device.

For a network to which PTN equipment is applied, equipment connected with the termination device A may perform packet processing about a bandwidth, latency management, and the like for best-effort, low-latency, or high-precision depending on a characteristic via the deterministic line unit 514 (a UNI ingress packet processing block or an NNI egress packet processing block) for the received packet and may transmit the processed packet to the network. Equipment connected with the termination device B may perform packet processing for best-effort, low-latency, or high-precision depending on a characteristic via the deterministic line unit 514 (an NNI ingress packet processing block or a UNI egress packet processing block) for the received packet and may transmit the processed packet to the termination device.

The deterministic line units 514 of equipment located in the middle of the network may perform packet relay processing, such as bandwidth and latency management according to a characteristic of the packet.

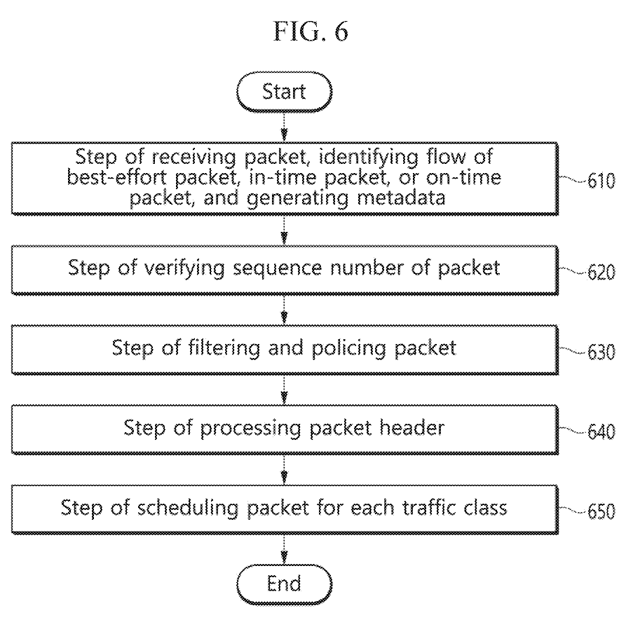

FIG. 6 illustrates a packing processing method in a deterministic network according to an embodiment of the present disclosure.

Referring to FIG. 6, the packing processing method in the deterministic network is composed of the following steps.

First of all, a flow lookup block may perform a step 610 of receiving a packet, identifying flow of a best-effort packet, an in-time packet, or an on-time packet, and generating metadata. The flow lookup block may perform a table lookup function for identifying best-effort/in-time/on-time packet flow for a packet input via an internal data interface from a network interface block (ingress) or a system interface block (egress) and may perform a header processing function for changing a packet header depending on the result obtained via it if necessary. Furthermore, the flow lookup block may generate information, such as a flow ID, MPLS mapping (FTN/ILM), a priority, a sequence number, a packet size obtained as a result of packet analysis and lookup in the form of metadata and may deliver the metadata to a next block independently of the packet of the internal data interface.

Next, a flow sequence check block may perform a step 620 of verifying a sequence number of the packet. The flow sequence check block may perform a table lookup function using a flow ID in the metadata for the packet input via the internal data interface from the flow lookup block and may check a sequence number of a previous received packet obtained via it. The flow sequence check block may discard a packet with the same sequence number as the previous received packet and may forward a packet with a sequence number which is not the same as the previous received packet to a filtering and policing block (ingress) or a duplicate packet removal block (egress).

The duplicate packet removal block may additionally operate in an egress direction. The duplicate packet removal block may perform a table lookup function using the flow ID in the metadata for the packet input via the internal data interface from the flow sequence check block and may check reception sequence history obtained via it (or sequence number reception history). The duplicate packet removal block may discard the packet, when there is previous reception history, and may deliver the packet to the filtering and policing block, when there is no reception history. This is a function for selecting a packet first received among packets copied and forwarded from another network equipment for lossless forwarding.

Next, the filtering and policing block may perform a step 630 of filtering and policing the packet. The filtering and policing block may perform a table lookup function using the flow ID in the metadata for the packet input via the internal data interface from the flow sequence check block (ingress) or the duplicate packet removal block (egress). The filtering and policing block may perform a function, such as filtering and policing for checking whether it is allowed for each flow obtained via it and a bandwidth used, stream gate control for allocating it to each stream gate corresponding to an input packet, specified output available time calculation according to a bandwidth or latency set for each flow, or statistics management and priority resetting for each flow. The filtering and policing block may add the table lookup and processing result performed above to the metadata and may deliver the metadata to a packet header processing block independently of the packet of the internal data interface.

Next, the packet header processing block may perform a step 640 of processing a packet header. The packet header processing block may perform a table lookup function using the flow ID in the metadata for the packet input via the internal data interface from the filtering and policing block and may perform a header processing function including encapsulation/decapsulation (MPLS pop/push/swap or the like) of a packet to be output based on the result obtained via it. The packet header processing block (ingress) may add a header (e.g., a VLAN ID or an MPLS label) for copying a packet via a switch fabric, when no-loss is required.

Finally, an output scheduling block may perform a step 650 of scheduling the packet for each traffic class. The output scheduling block may divide traffic classes with reference to priorities in the metadata for the packet input via the internal data interface from the packet header processing block and may store the divided traffic classes in a class queue. The output scheduling block may support configurable traffic class queues up to 8 and may selectively apply the following various scheduling schemes.

(1) Strict priority-based forwarding for dividing packets for each traffic flow and transmitting the packets depending on priorities of the traffic classes

(2) Time-aware shaping for dividing and storing packets for each traffic flow in each class queue and controlling a gate operation of a specific class queue in a predetermined time interval to ensure transmission latency of the packet

(3) Cyclic queuing and forwarding for repeating a process of alternately storing and transmitting packets with the same characteristic in a predetermined time interval using two traffic class queues to finalize latency on a network to be predictable

(4) Asynchronous traffic shaping for asynchronously controlling the output of packets using an output available time calculated based on a local time

(5) Delay-based forwarding for ensuring in-time/on-time using a push-in-first out (PIFO) queue and resource-based on-time forwarding for improving it

Via such a packing processing method, a deterministic packing processing module is able to forward an end-to-end low-latency time sensitive packet (e.g., AR/VR/MR or the like) and a high-precision mission-critical packet (e.g., industry control, remote surgery, or the like) and may ensure a bandwidth, maximum allowable latency, a minimum latency deviation, no-loss, or the like, although congestion with existing best-effort traffic occurs.

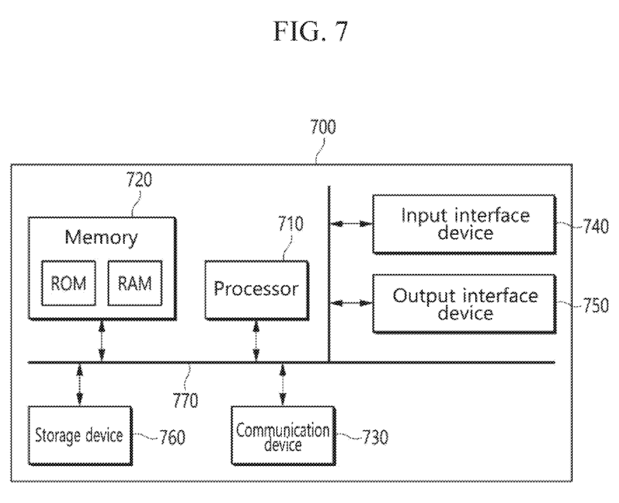

FIG. 7 is a drawing illustrating a device configuration according to an embodiment.

Referring to FIG. 7, a device 700 may include at least one processor 710, a memory 720, and a communication device 730 connected with a network to perform communication. Furthermore, the device 700 may further include an input interface device 740, an output interface device 750, a storage device 760, and the like. The respective components included in the device 700 may be connected with each other by a bus 720 to communicate with each other.

However, the respective components included in the device 700 may be connected with each other via an individual interface or an individual bus around the processor 710, rather than the common bus 770. For example, the processor 710 may be connected with at least one of the memory 720, the communication device 730, the input interface device 740, the output interface device 750, and the storage device 760 via a dedicated interface.

The processor 710 may execute a program command stored in at least one of the memory 720 and the storage device 760. The processor 710 may refer to a central processing unit (CPU), a graphics processing unit (GPU), or a dedicated processor in which methods according to embodiments of the present disclosure are performed. Each of the memory 720 and the storage device 760 may be composed of at least one of a volatile storage medium and a non-volatile storage medium. For example, the memory 720 may be composed of at least one of a read only memory (ROM) and a random access memory (RAM).

Methods according to claims of the present disclosure or embodiments described in the specification may be implemented in the form of hardware, software, or a combination of hardware and software.

When they are implemented with software, a computer-readable storage medium for storing one or more programs (or software modules) may be provided. The one or more programs stored in the computer-readable storage medium are configured to be executable by one or more processors in an electronic device. The one or more programs include instructions causing the electronic device to execute methods according to the claims of the present disclosure or the embodiments described in the specification.

Such a program (or a software module or software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs) or an another type of optical storage device, or a magnetic cassette. Alternatively, the program may be stored in a memory configured as a combination of some or all thereof. Furthermore, each configuration memory may be included in plural.

Furthermore, the program may be stored in an attachable storage device accessible over a communication network, such as the Internet, an intranet, a local area network (LAN), a wide area network (WAN), or a storage area network (SAN), or a communication network composed of a combination thereof. Such a storage device may access a device for performing an embodiment of the present disclosure via an external port. Furthermore, a separate storage device on the communication network may access a device for performing an embodiment of the present disclosure.

In detailed embodiments of the above-mentioned present disclosure, a component included in the present disclosure is expressed in a singular or plural form according to the proposed detailed embodiment. However, the expression in the singular or plural form is selected to be suitable for a situation proposed for convenience of description. The present disclosure is not limited to a singular component or a plurality of components. Even components expressed in the plural form may be configured in the singular form, but a component expressed in the singular form may be configured in the plural form.

The apparatus and the method according to various embodiments of the present disclosure may load a deterministic packing processing module into a line unit to provide a deterministic networking service in a wide area network.

Furthermore, the apparatus and the method according to various embodiments of the present disclosure may apply a processing scheme differentiated according to a characteristic of a packet to ensure low-latency forwarding of a time sensitive packet and high-precision forwarding of a mission-critical packet even in a congestion situation with existing best-effort traffic.

Furthermore, the apparatus and the method according to various embodiments of the present disclosure may provide various scheduling schemes and a duplicate packet removal function to ensure quality of service (QoS), such as a bandwidth, latency, a latency deviation, or no-loss of the packet.

Furthermore, the apparatus and the method according to various embodiments of the present disclosure may support a time sensitive networking (TSN) and deterministic networking (DetNet) standard technology to provide deterministic networking service interworking between a local area network and a wide area network.

The effects that are achieved through the present disclosure may not be limited to the effects described above, and other advantages not described above may be more clearly understood from the following detailed description by those skilled in the art to which the present disclosure pertains.

Meanwhile, while the present disclosure has been described with reference to detailed embodiments, it will be apparent that various changes and modifications may be made without departing from the spirit and scope of the present disclosure. Therefore, the spirit and scope of the present disclosure is not limited and determined by the described embodiment and should be determined by the scope and equivalents of the claims as well as the scope of the claims which will be described below.

What is claimed is:

1. An apparatus for deterministic networking packet processing in a communication system, the apparatus comprising:
an interface block group;
a packing processing block group; and
a packet buffering block,
wherein the interface block group includes:
a network interface block for a connection with an optical module;
a system interface block for a connection with a switch interface module;
a time synchronization interface block for a connection with a time synchronization module; and
a processor interface block for a connection with a local processor,
wherein the packing processing block group includes:
a flow lookup block configured to identify flow of a best-effort packet, an in-time packet, or an on-time packet and generate metadata;
a flow sequence check block configured to verify a sequence number of a packet;
a duplicate packet removal block configured to remove a packet with sequence number reception history;
a filtering and policing block configured to filter and police the packet;
a packet header processing block configured to process a packet header; and
an output scheduling block configured to schedule the packet for each traffic class.

2. The apparatus of claim 1, wherein the packing processing block group is configured to separately operate in an ingress direction from a network to a system and an egress direction from the system to the network, and
wherein the duplicate packet removal block is configured to operate only in the egress direction.

3. The apparatus of claim 2, wherein the duplicate packet removal block in the packing processing block group in the egress direction is located between the flow sequence check block and the filtering and policing block and is configured to remove a packet copied by multi-path transmission of the same flow.

4. The apparatus of claim 1, wherein the network interface block in the interface block group is configured to convert an Ethernet signal into an internal data interface signal,
wherein the system interface block in the interface block group is configured to convert an interlaken or Ethernet signal into an internal data interface signal,
wherein the time synchronization interface block in the interface block group is configured to receive global time information via a precision time protocol (PTP) and update a current time, and
wherein the processor interface block in the interface block group is configured to communicate with an external processor to set a lookup table and a register.

5. The apparatus of claim 1, wherein the flow lookup block in the packing processing block group is configured to generate the metadata including a flow identifier (ID) obtained as a result of packet analysis, multi-protocol label switching (MPLS) mapping, a priority, a sequence number, or a packet size,
wherein the flow sequence check block in the packing processing block group is configured to perform comparison with a sequence number of a previous received packet to discard a packet with the same sequence number,
wherein the duplicate packet removal block in the packing processing block group is configured to check reception sequence history to discard a packet with previous reception history,
wherein the filtering and policing block in the packing processing block group is configured to check whether it is allowed for each flow and a bandwidth used, control a stream gate, and calculate an output available time,
wherein the packet header processing block in the packing processing block group is configured to perform encapsulation or decapsulation including MPLS pop, push, or swap, and
wherein the output scheduling block in the packing processing block group is configured to support a maximum of 8 traffic class queues and schedule the packet in at least one of strict priority-based forwarding, time-aware shaping, cyclic queuing and forwarding, asynchronous traffic shaping, delay-based forwarding, or resource-based on-time forwarding.

6. The apparatus of claim 1, wherein the packet buffering block is configured to store and output the packet in an internal or external memory and perform a buffer management function for data transfer between the respective blocks of the packing processing block group.

7. A method for deterministic networking packing processing, the method comprising:
receiving a packet, identifying flow of a best-effort, in-time, or on-time packet, and generating metadata;
verifying a sequence number of the packet;
removing a packet with sequence number reception history;
filtering and policing the packet;
processing a packet header; and
scheduling the packet for each traffic class.

8. The method of claim 7, wherein the packet processing is separately performed in an ingress direction from a network to a system and an egress direction from the system to the network, and
wherein the removing of the packet with the sequence number reception history is performed only in the egress direction.

9. The method of claim 8, wherein the removing of the packet with the sequence number reception history in the packing processing in the egress direction is performed between sequence verification and filtering to remove a packet copied by multi-path transmission of the same flow.

10. The method of claim 7, further comprising:
converting an Ethernet signal into an internal data interface signal;
converting an interlaken or Ethernet signal into an internal data interface signal;
receiving global time information via a precision time protocol (PTP) and updating a current time; and
communicating with an external processor to set a lookup table and a register.

11. The method of claim 9, further comprising:
generating the metadata including a flow identifier (ID) obtained as a result of packet analysis, multi-protocol label switching (MPLS) mapping, a priority, a sequence number, or a packet size;
performing comparison with a sequence number of a previous received packet to discard a packet with the same sequence number;
checking reception sequence history to discard a packet with previous reception history;
checking whether it is allowed for each flow and a bandwidth used, controlling a stream gate, and calculating an output available time;
performing encapsulation or decapsulation including MPLS pop, push, or swap; and
supporting a maximum of 8 traffic class queues and scheduling the packet in at least one of strict priority-based forwarding, time-aware shaping, cyclic queuing and forwarding, asynchronous traffic shaping, delay-based forwarding, or resource-based on-time forwarding.
